(19) United States
(12) Patent Application Publication
(10) Pub. No.: US 2026/0211563 A1
(43) Pub. Date: Jul. 23, 2026

(54) OPTIMIZING SEARCHING OF LOGICAL-TO-PHYSICAL (L2P) ADDRESS TRANSLATION TABLE ENTRIES IN DATA STORAGE DEVICES

(71) Applicant: Sandisk Technologies, Inc., Milpitas, CA (US)

(72) Inventors: HAREESH CHITIKESI, Bangalore (IN); GNANASEKAR KUPPUSWAMY, Bangalore (IN); RAMANATHAN MUTHIAH, Bangalore (IN)

(73) Assignee: Sandisk Technologies, Inc., Milpitas, CA (US)

(21) Appl. No.: 19/032,509

(22) Filed: Jan. 21, 2025

(51) Int. Cl. G06F 3/06

(52) U.S. Cl. CPC G06F 3/0625; G06F 3/0655; G06F 3/0679

(57) ABSTRACT

A storage device optimizes power usage through selective execution of a hardware engine. A hardware engine on the device may perform a specific task using operational power provided by the storage device. A controller may also perform the specific task using processing power of the storage device. The controller compares an efficiency of the hardware engine in performing the specific task in a given time unit against the operational power. The controller keeps the hardware engine in an idle state or switches off the hardware engine and executes the specific task when the specific task can be performed within the given time unit with a given level of efficiency. The controller invokes the hardware engine to execute the specific task when the controller cannot execute the specific task within the given time unit with the given level of efficiency.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in blocks on the memory device. Data stored in blocks on the memory device may be assigned a logical block address (LBA) that provides a unique identifier to the individual block. The LBAs may be mapped one-to-one to physical addresses on the memory device. The one-to-one LBA to physical address mappings may be stored in a logical-to-physical (L2P) table. A controller on the storage device may manage the mapping of LBAs to physical locations within the memory device.

To improve the capabilities of the storage device, one or more hardware engines that are configured to perform specific tasks may be added to the storage device. For example, a GAT Delta Scan and Eviction (GDSE) hardware engine may be configured to efficiently search L2P delta entries in a cache and evict L2P pages to the memory device under the supervision of a flash translation layer (FTL) module. The GDSE hardware engine may be added to the storage device to improve the capability of the storage device in addressing random workloads rather than having these tasks performed by the controller.

The host typically provides the power used by the storage device and power savings in a storage device may be valuable. For example, when a storage device is used in a battery-operated host system, the storage device may be power sensitive. In some cases, the tasks assigned to a hardware engine may be carried out by the controller/processor, wherein when the controller performs the task, the controller may use the processing power being provided by the host to keep the storage device operational. Executing the task for which a hardware engine is configured on the hardware engine may typically be more efficient than using the controller to execute the task, although in some cases, the controller may execute the operations of the hardware engine with comparable efficiency.

A hardware engine may consume a lower amount of power when it is not in operation (i.e., when it is in a base power mode) than when it is executing a task (i.e., when it is in an operational power mode). When a tasks assigned to a hardware engine is carried out by the controller instead of the hardware engine, the hardware engine may remain in an idle state and consume power in the base power mode. When the hardware engine is in operational power mode, the hardware engine may consume a variable amount of power as per the task being executed. In cases where the controller can execute a task with comparable efficiency as the hardware engine, power may be conserved when the controller executes the task. However, when a storage device includes a hardware engine that is configured to perform a specific task, the storage device is configured to execute the hardware engine when the task needs to be performed. There is currently no mechanism for optimizing power usage on the storage device through selective execution of a hardware engine.

### SUMMARY OF THE INVENTION

In some implementations, a storage device may optimize power usage through selective execution of a hardware engine. The storage device includes a hardware engine configured to perform a specific task on the storage device using operational power provided by the storage device. A controller may also be configured to perform the specific task using processing power of the storage device. The controller may compare an efficiency of the hardware engine in performing the specific task in a given time unit against the operational power. The controller may keep the hardware engine in an idle state or switch off the hardware engine and execute the specific task when the controller can execute the specific task within the given time unit with a given level of efficiency. The controller may invoke the hardware engine to execute the specific task when the controller cannot execute the specific task within the given time unit with the given level of efficiency. When the controller invokes the hardware engine, the storage device consumes the processing power and the operational power.

.In some implementations, a method is provided for optimizing power usage on a storage device through selective execution of a hardware engine. The method includes comparing an efficiency of a hardware engine configured to perform a specific task in a given time unit against an operational power provided by the storage device. The method also includes keeping the hardware engine in an idle state or switching off the hardware engine and executing the specific task when the controller can execute the specific task within the given time unit with a given level of efficiency. The method further includes invoking the hardware engine to execute the specific task when the controller cannot execute the specific task within the given time unit with the given level of efficiency. When the controller invokes the hardware engine the storage device consumes the processing power and the operational power.

In some implementations, a method is provided for optimizing power usage on a storage device through selective execution of a hardware engine. The method includes receiving a read request on the storage device. The method also includes determining that a threshold for switching to a hardware engine configured to perform a specific task in a given time unit using operational power provided by the storage device is met, that the storage device is not operating in a low power mode, and that the storage device is not operating in a first thermal state and invoking the hardware engine to execute the specific task. The method further includes determining that the threshold for switching to the hardware engine is not met, that the storage device is operating in a low-power mode, or that the storage device is operating in the first thermal state and executing the specific task.

### BRIEF DESCRIPTION OF THE DRAWINGS

FIG. 1 is a schematic block diagram of an example system in accordance with some implementations.

FIG. 2 is an example flow diagram for optimizing power usage on a storage device through selective execution of the hardware engine in accordance with some implementations.

FIG. 3 is an example flow diagram for optimizing power usage on a storage device through selective execution of the hardware engine based on a workload in accordance with some implementations.

FIG. 4 is an example flow diagram for optimizing power usage on a storage device through selective execution of the hardware engine based on availability of a resource in accordance with some implementations.

FIG. 5 is an example flow diagram for optimizing power usage on a storage device through selective execution of the hardware engine based on a power state in accordance with some implementations.

FIG. 6 is an example flow diagram for optimizing power usage on a storage device through selective execution of the hardware engine based on a protocol being used on the storage device in accordance with some implementations.

FIG. 7 is another example flow diagram for optimizing power usage on a concurrent-protocol storage device through selective execution of the hardware engine in accordance with some implementations.

FIG. 8 is an example flow diagram for optimizing power usage on a storage device when executing a read request in accordance with some implementations.

FIG. 9 is a diagram of an example environment in which systems and/or methods described herein are implemented.

FIG. 10 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

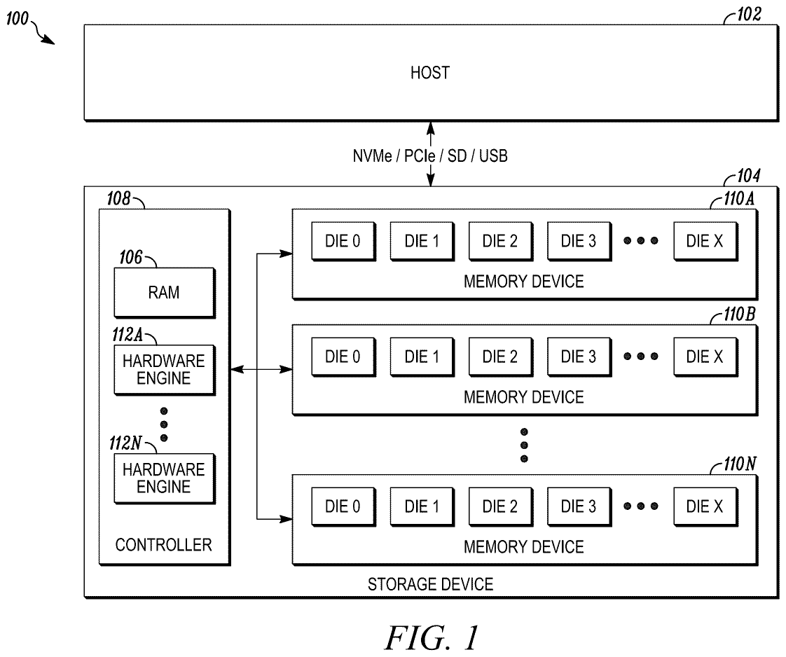

FIG. 1 is a schematic block diagram of an example system in accordance with some implementations. System 100 includes a host 102 and a storage device 104. Host 102 may transmit commands to read or write data to storage device 104. Host 102 and storage device 104 may be in the same physical location as components on a single computing device or on different computing devices that are communicatively coupled. Host 102 may supply operation power to storage device 104. Host 102 may include additional components (not shown in this figure for the sake of simplicity).

Storage device 104 may include a random-access memory (RAM) 106, a controller 108, one or more non-volatile memory devices 110a-110n (referred to herein as the memory device(s) 110), and one or more hardware engines 112a-112n (referred to herein as hardware engine(s) 112). Storage device 104 may be, for example, a solid-state drive (SSD) that may operate in one or more modes using one or more protocols. For example, storage device 104 may operate in a Non-Volatile Memory Express (NVMe) mode and/or in a secure digital (SD) mode or storage device 104 may operate in the NVMe mode and/or in a Universal Serial Bus (USB) mode. The SD and USB modes may be lower quality-of-service modes and the NVMe mode may be a higher quality-of-service mode. Storage device 104, in various implementations, may be disposed in one or more different locations relative to the host 102 and storage device 104 may communicate with host 102 over a NVMe/peripheral component interconnect express (PCIe) protocol, SD protocol, USB protocol, and the like.

RAM 106 may be static RAM (SRAM) or dynamic RAM (DRAM) that may be used to cache information used on storage device 104. Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may execute garbage collection, read refresh, and other relocation functions per internal relocation algorithms to refresh, recycle, and/or relocate the data on memory device 110. Controller 108 may also manage how storage device 104 uses power provided by host 102.

Memory device 110 may be flash based. For example, memory device 110 may be a NAND or NOR flash memory that may be used for storing host and control data over the operational life of memory device 110. Memory device 110 may include multiple dies (for example, DIE 0-DIE X) that may be divided into blocks to store data, wherein the data may be stored in various formats. Memory device 110 may be included in storage device 104 or may be otherwise communicatively coupled to storage device 104.

A hardware engine 112 may be configured to perform a specific task on storage device 104, wherein hardware engine 112 may consume power provided by storage device. When hardware engine 112 is performing the task for which it is configured, hardware engine 112 may consume power in an operational power mode. When hardware engine 112 is not performing the task for which it is configured, hardware engine 112 may be in an idle state and may consume power in a base power mode. The power consumed by hardware engine 112 in the base power mode may be less than the power consumed by hardware engine 112 in the operational power mode. Controller 108 and/or a corresponding module/processor (referred to generally as controller 108) may perform the task(s) which hardware engine 112 is configured to perform. When controller 108 performs the task that hardware engine 112 is configured to perform, controller 108 may use the processing power being supplied by host 102 to operate storage device 104.

Storage device 104 may include one or more thresholds that may be defined according to, for example, quality-of-service (QoS) requirements including, for example, QoS requirements that are associated with workloads, resources, power states and/or power modes. Controller 108 may use a threshold to determine if a task or consolidated tasks that need to be performed within a given time unit may be efficiently performed by hardware engine 112 that is configured to perform the task. In determining the efficiency of hardware engine 112 in performing a task, controller 108 may compare the efficiency of hardware engine 112 against the power consumption of hardware engine 112. When controller 108 determines that it can perform the task while meeting a given quality-of-service requirement (i.e., with a given level of efficiency), controller 108 may keep hardware engine 112 in the base power mode to conserve the power that would otherwise be consumed by hardware engine 112 in performing the tasks. Keeping hardware engine 112 running (or idling in the base power mode) when hardware engine 112 is not performing work within a given time window may impact the energy efficiency of storage device 104. In some cases, to conserve the power that would otherwise be consumed by an idle hardware engine 112 when controller 108 determines that it can perform the task that hardware engine 112 is configured to perform within a given time unit, while meeting a given quality-of-service requirement, controller 108 may switch off hardware engine 112.

Consider an example where hardware engine 112 may be configured to process videos. Controller 108 may identify the videos to be processed within a given time window and may determine if the rate of frame processing to be carried out is more than a video processing threshold. If controller 108 determines that the rate of frame processing to be carried out is less than a video processing threshold, controller 108 may switch off hardware engine 112 or keep hardware engine 112 in a base power mode and controller 108 may process the video frames using the processing power for operating storage device 104. If controller 108 determines that the rate of frame processing to be carried out is more than or equal to the video processing threshold, controller 108 may invoke hardware engine 112 to process the video frames. When hardware engine 112 processes the video frames, hardware engine 112 may enter the operational power mode. As such, when controller 108 invokes hardware engine 112, storage device 104 may consume the processing power used to run storge device 105 and the operational power of hardware engine 112.

In another example, a Global Address Table (GAT) Delta Scan and Eviction (GDSE) hardware engine 112 may be configured to perform searches on recently written GAT delta entries in a cache and return a specific mapping for a logical block. The delta search may be performed in a read path. GDSE hardware engine 112 may evict L2P pages to memory device 110 under the supervision of a flash translation layer (FTL) module (not shown). GDSE hardware engine 112 may be used to improve the performance of storage device 104 in addressing random workloads. Controller 108 may also execute the functions for which GDSE hardware engine 112 is configured. When controller 108 executes the functions for which GDSE hardware engine 112 is configured, for example, for sequential workloads, controller 108 may execute those functions with the same or comparable level of efficiency as GDSE hardware engine 112 (i.e., with a given level of efficiency). In some circumstances (for example, for random workloads), controller 108 may take more time in executing the functions of GDSE hardware engine 112.

In optimizing power usage on the storage device through selective execution of GDSE hardware engine 112, controller 108 may evaluate the workload associated with a task and may invoke GDSE hardware engine 112 or switch off hardware engine 112 based on the workload. In one example, to balance the power consumed by GDSE hardware engine 112 against the operational efficiency of GDSE hardware engine 112, controller 108 may determine if a workload threshold has been reached by, for example, evaluating the amount of random workload and the rate of accumulation of L2P delta entries within a given time window. The workload threshold may be defined according to, for example, a random workload quality-of-service requirement and/or power modes. Random workloads may generate more L2P delta entries (for example, generate L2P delta entries at a higher rate) and require more eviction and consolidation per unit time than sequential workloads. As controller 108 monitors the accumulated random workload per unit time, controller 108 may determine if it can perform the tasks of GDSE hardware engine 112 within the given time window at a given level of efficiency (for example, by meeting a predefined quality-of-service requirement). If controller 108 determines, that it can execute the L2P flow of search, eviction, and consolidation of L2P entries with a given level of efficiency as GDSE hardware engine 112, controller 108 may switch off GDSE hardware engine 112, even though GDSE hardware engine 112 may be available to perform the tasks being performed by controller 108.

If controller 108 determines that it cannot perform the tasks of GDSE hardware engine 112 within the given time window and with the given level of efficiency, controller 108 may switch to GDSE hardware engine 112. For example, controller 108 may switch to GDSE hardware engine 112 for L2P tasks when controller 108 determines that the number of the L2P delta entries in the cache is more than the workload threshold, thereby ensuring that the work being performed by GDSE hardware engine 112 may be worth a tradeoff for the power consumed by GDSE hardware engine 112 in an operational mode. When GDSE hardware engine 112 is in the operational power mode, the power consumed in the operational power mode may vary according to the workload and GDSE hardware engine 112 may consume more power in the operational power mode than it would in the base power mode. Thus, controller 108 may balance an efficiency factor against a workload threshold in determining if executing GDSE hardware engine 112 may be a good trade-off when taking the power consumed by GDSE hardware engine 112 to perform a task within a given time unit into consideration.

Controller 108 may also evaluate the resource available to perform a task and may invoke hardware engine 112 or switch hardware engine 112 off based on the availability of the resource. For example, controller 108 may also evaluate an associated GAT cache to identify the number of L2P pages that may be moved in an L2P eviction in a write path. Controller 108 may determine if the number of control pages is above a control page threshold, and if it is, controller 108 may invoke GDSE hardware engine 112 for optimum eviction of the control pages. The control page threshold may be set such that when the number of pages to be evicted is above the control page threshold, controller 108 may determine that using GDSE hardware engine 112 may be good tradeoff against the operational power that may be consumed by GDSE hardware engine 112. Controller 108 may also monitor the amount of space available in the GAT cache. If space in the GAT cache is limited, controller 108 may determine that executing GDSE hardware engine 112 may be sub-optimal even if the number of control pages is above a control page threshold. Controller 108 may also determine that the returns from GDSE hardware engine 112 may not be maximized since the GAT cache would be a bottleneck. Thus, controller 108 may choose between performing the eviction of the control pages or invoking GDSE hardware engine 112 for optimum eviction of the control pages based on an available resource (for example, the amount of available space in the GAT cache).

Controller 108 may also evaluate a power state and/or power mode of storage device 104 and may determine whether to invoke GDSE hardware engine 112 based on the power mode and/or power state. If storage device 104 is operating in a low power mode or if host 102 instructs storage device 104 to operate in a low power mode, controller may perform the tasks of GDSE hardware engine 112 and controller 108 may switch GDSE hardware engine 112 off. If storage device 104 is operating in a active/full-power mode (i.e., a power mode above a low power mode threshold), controller 108 may invoke GDSE hardware engine 112 when other conditions associated with resources availability and threshold(s) limits are met. If controller 108 determines that storage device 104 is operating in a first thermal zone/state (for example, a thermal zone/state that is above a predefined normal thermal zone/state), controller 108 may perform the tasks of GDSE hardware engine 112 and controller 108 may switch GDSE hardware engine 112 off. If storage device 104 is operating in a low/second/predefined normal thermal state (i.e., a state below a first thermal state), controller 108 may invoke GDSE hardware engine 112 when other conditions associated with resources availability and threshold(s) limits are met.

In cases where storage device 104 operates using multiple protocols, controller 108 may switch off GDSE hardware engine 112 when it determines that the mode of operation is associated with a low quality-of-service. As an example, controller 108 in storage device 104 operating in a SD mode (and using a protocol referred to herein as a first protocol) and a NVMe mode (and using a protocol referred to herein as a second protocol) may switch off GDSE hardware engine 112 in the SD mode (i.e., using the first protocol) and enable GDSE hardware engine 112 in the NVMe mode (i.e., using the second protocol). A storage device 104 operating in SD and NVMe modes may be a power and thermal sensitive device owing to its SD form factor, hence controller 108 may limit or restrict execution of hardware engine 112 when there are strict power requirements in storage device 104.

When storage device 104 is a concurrent-protocol device where the input/output (IO) operations from multiple modes are to be supported concurrently, depending on the IO operations for the protocol being served, controller 108 may enable hardware engine 112. For example, storage device 104 may be configured to concurrently support NVMe (i.e., using the second protocol) and USB IO operations (i.e., using the first protocol), wherein the overall IO operations per second for the USB protocol may be less than that of the NVMe protocol. Controller 108 may enable hardware engine 112 when at least NVMe commands are to be served or controller 108 may power off hardware engine 112 when it determines that only the IO operations related to the USB protocol are to be served.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

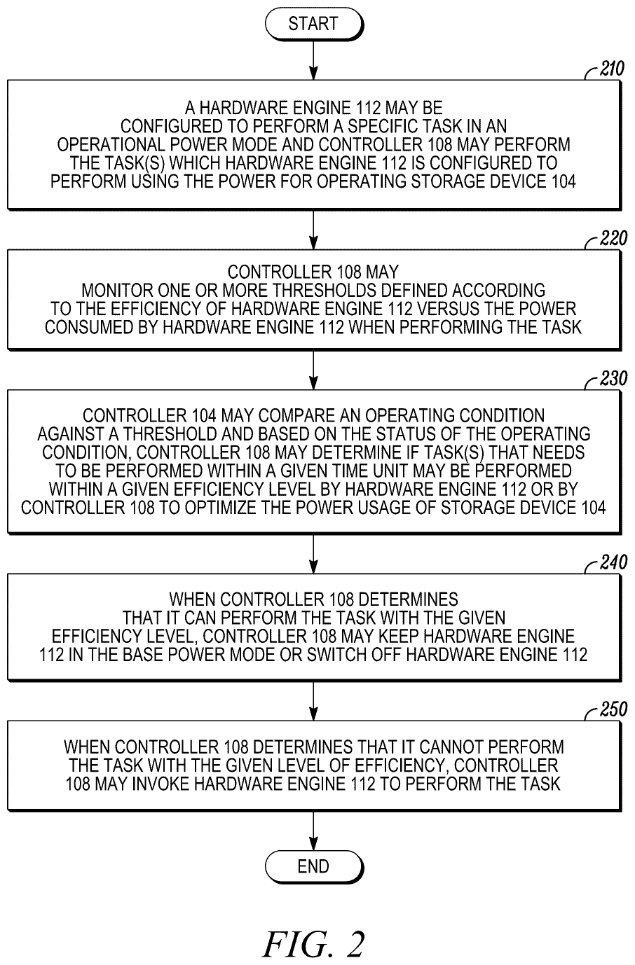

FIG. 2 is an example flow diagram for optimizing power usage on a storage device through selective execution of the hardware engine in accordance with some implementations. At 210, a hardware engine 112 may be configured to perform a specific task in an operational power mode and controller 108 may perform the task(s) which hardware engine 112 is configured to perform using the power for operating storage device 104. At 220, controller 108 may monitor one or more thresholds defined according to the efficiency of hardware engine 112 versus the power consumed by hardware engine 112 when performing the task. At 230, controller 104 may compare an operating condition against a threshold and based on the status of the operating condition, controller 108 may determine if task(s) that needs to be performed within a given time unit may be performed within a given efficiency level by hardware engine 112 or by controller 108 to optimize the power usage of storage device 104. At 240, when controller 108 determines that it can perform the task with the given efficiency level, controller 108 may keep hardware engine 112 in the base power mode or switch off hardware engine 112. At 250, when controller 108 determines that it cannot perform the task with the given level of efficiency, controller 108 may invoke hardware engine 112 to perform the task. As indicated above FIG. 2 is provided as an example. Other examples may differ from what is described in FIG. 2.

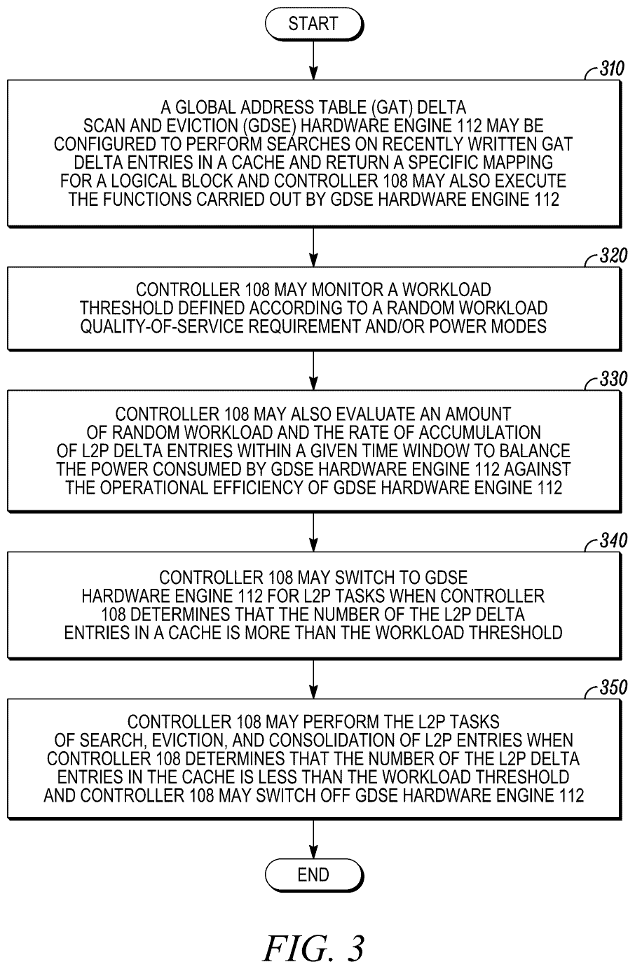

FIG. 3 is an example flow diagram for optimizing power usage on a storage device through selective execution of the hardware engine based on a workload in accordance with some implementations. At 310, a Global Address Table (GAT) Delta Scan and Eviction (GDSE) hardware engine 112 may be configured to perform searches on recently written GAT delta entries in a cache and return a specific mapping for a logical block and controller 108 may also execute the functions carried out by GDSE hardware engine 112. At 320, controller 108 may monitor a workload threshold defined according to a random workload quality-of-service requirement and/or power modes. At 330, controller 108 may also evaluate an amount of random workload and the rate of accumulation of L2P delta entries within a given time window to balance the power consumed by GDSE hardware engine 112 against the operational efficiency of GDSE hardware engine 112. At 340, controller 108 may switch to GDSE hardware engine 112 for L2P tasks when controller 108 determines that the number of the L2P delta entries in a cache is more than the workload threshold. At 350, controller 108 may perform the L2P tasks of search, eviction, and consolidation of L2P entries when controller 108 determines that the number of the L2P delta entries in the cache is less than the workload threshold and controller 108 may switch off GDSE hardware engine 112. As indicated above FIG. 3 is provided as an example. Other examples may differ from what is described in FIG. 3.

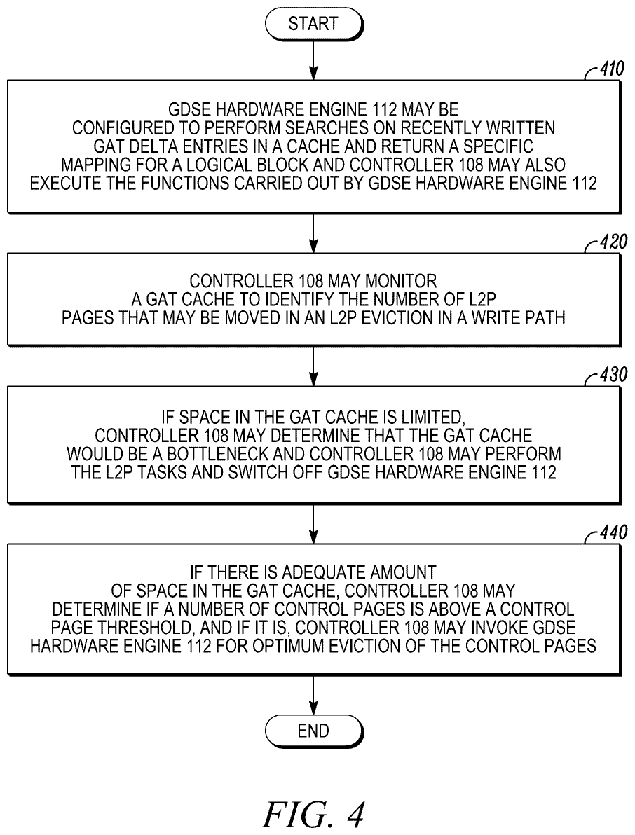

FIG. 4 is an example flow diagram for optimizing power usage on a storage device through selective execution of the hardware engine based on availability of a resource in accordance with some implementations. At 410, GDSE hardware engine 112 may be configured to perform searches on recently written GAT delta entries in a cache and return a specific mapping for a logical block and controller 108 may also execute the functions carried out by GDSE hardware engine 112. At 420, controller 108 may monitor a GAT cache to identify the number of L2P pages that may be moved in an L2P eviction in a write path. At 430, if space in the GAT cache is limited, controller 108 may determine that the GAT cache would be a bottleneck and controller 108 may perform the L2P tasks and switch off GDSE hardware engine 112. At 440, if there is adequate amount of space in the GAT cache, controller 108 may determine if a number of control pages is above a control page threshold, and if it is, controller 108 may invoke GDSE hardware engine 112 for optimum eviction of the control pages. As indicated above FIG. 4 is provided as an example. Other examples may differ from what is described in FIG. 4.

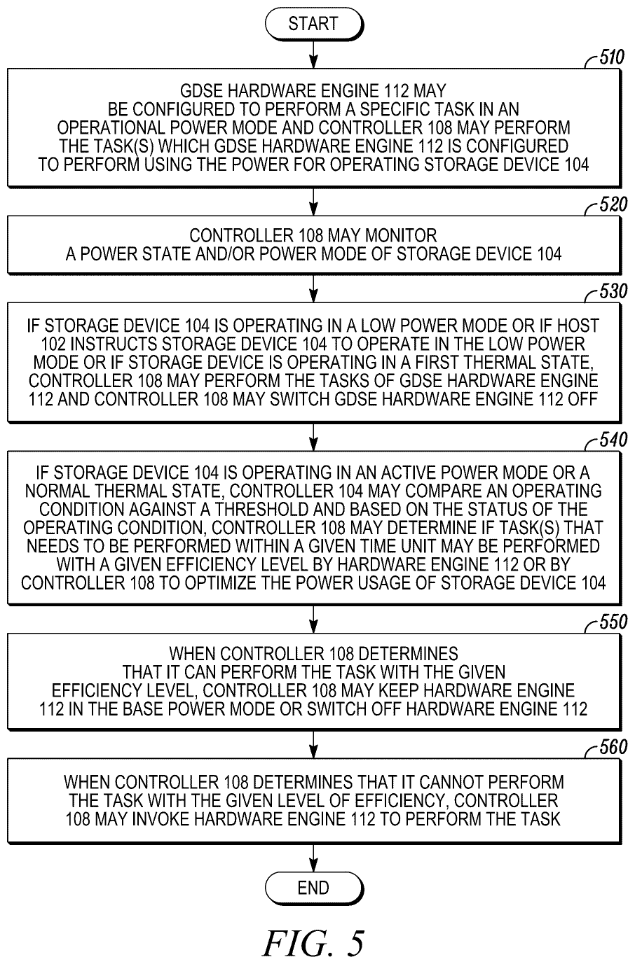

FIG. 5 is an example flow diagram for optimizing power usage on a storage device through selective execution of the hardware engine based on a power state in accordance with some implementations. At 510, GDSE hardware engine 112 may be configured to perform a specific task in an operational power mode and controller 108 may perform the task(s) which GDSE hardware engine 112 is configured to perform using the power for operating storage device 104. At 520, controller 108 may monitor a power state and/or power mode of storage device 104. At 530, if storage device 104 is operating in a low power mode or if host 102 instructs storage device 104 to operate in the low power mode or if storage device is operating in a first thermal state, controller 108 may perform the tasks of GDSE hardware engine 112 and controller 108 may switch GDSE hardware engine 112 off. At 540, if storage device 104 is operating in an active power mode or a normal/second thermal state, controller 104 may compare an operating condition against a threshold and based on the status of the operating condition, controller 108 may determine if task(s) that needs to be performed within a given time unit may be performed with a given efficiency level by hardware engine 112 or by controller 108 to optimize the power usage of storage device 104. At 550, when controller 108 determines that it can perform the task with the given efficiency level, controller 108 may keep hardware engine 112 in the base power mode or switch off hardware engine 112. At 560, when controller 108 determines that it cannot perform the task with the given level of efficiency, controller 108 may invoke hardware engine 112 to perform the task. As indicated above FIG. 5 is provided as an example. Other examples may differ from what is described in FIG. 5.

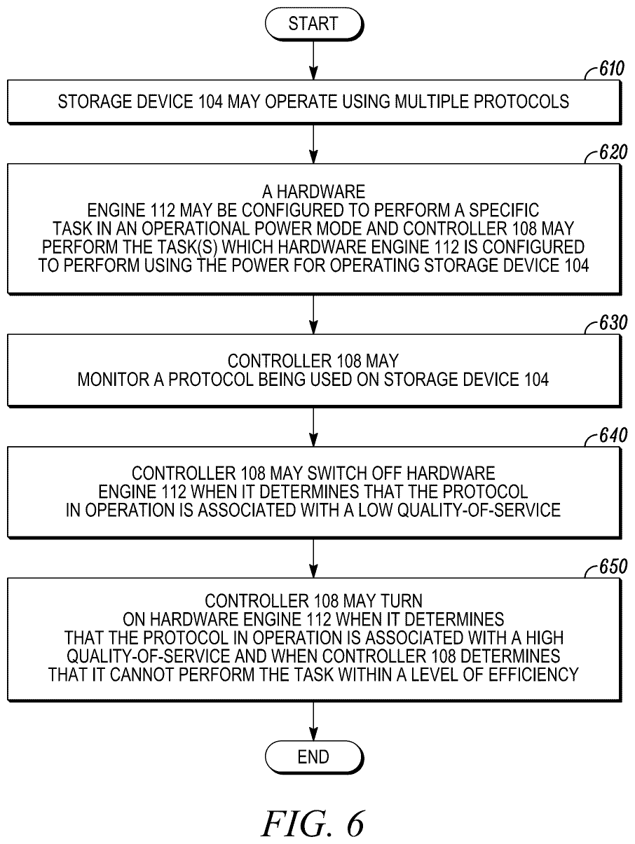

FIG. 6 is an example flow diagram for optimizing power usage on a storage device through selective execution of the hardware engine based on a protocol being used on the storage device in accordance with some implementations. At 610, storage device 104 may operate using multiple protocols. At 620, a hardware engine 112 may be configured to perform a specific task in an operational power mode and controller 108 may perform the task(s) which hardware engine 112 is configured to perform using the power for operating storage device 104. At 630, controller 108 may monitor a protocol being used on storage device 104. At 640, controller 108 may switch off hardware engine 112 when it determines that the protocol in operation is associated with a low quality-of-service. At 650, controller 108 may turn on hardware engine 112 when it determines that the protocol in operation is associated with a high quality-of-service and when controller 108 determines that it cannot perform the task within a level of efficiency. As indicated above FIG. 6 is provided as an example. Other examples may differ from what is described in FIG. 6.

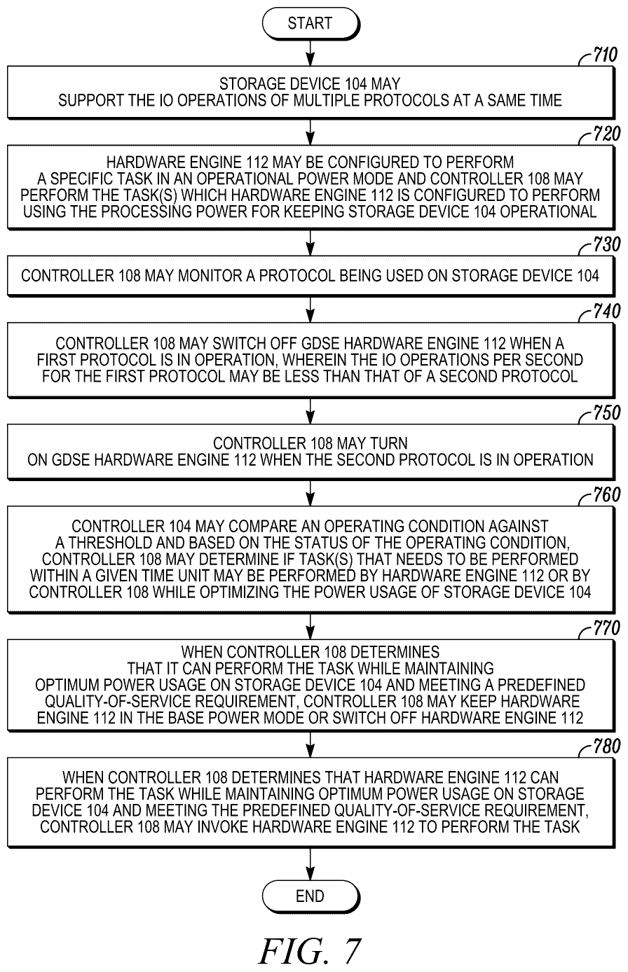

FIG. 7 is another example flow diagram for optimizing power usage on a concurrent-protocol storage device through selective execution of the hardware engine in accordance with some implementations. At 710, storage device 104 may support the IO operations of multiple protocols at a same time. At 720, hardware engine 112 may be configured to perform a specific task in an operational power mode and controller 108 may perform the task(s) which hardware engine 112 is configured to perform using the processing power for keeping storage device 104 operational. At 730, controller 108 may monitor a protocol being used on storage device 104. At 740, controller 108 may switch off GDSE hardware engine 112 when a first protocol is in operation, wherein the IO operations per second for the first protocol may be less than that of a second protocol. At 750, controller 108 may turn on GDSE hardware engine 112 when the second protocol is in operation. At 760, controller 104 may compare an operating condition against a threshold and based on the status of the operating condition, controller 108 may determine if task(s) that needs to be performed within a given time unit may be performed by hardware engine 112 or by controller 108 while optimizing the power usage of storage device 104. At 770, when controller 108 determines that it can perform the task while maintaining optimum power usage on storage device 104 and meeting a predefined quality-of-service requirement, controller 108 may keep hardware engine 112 in the base power mode or switch off hardware engine 112. At 780, when controller 108 determines that hardware engine 112 can perform the task while maintaining optimum power usage on storage device 104 and meeting the predefined quality-of-service requirement, controller 108 may invoke hardware engine 112 to perform the task. As indicated above FIG. 7 is provided as an example. Other examples may differ from what is described in FIG. 7.

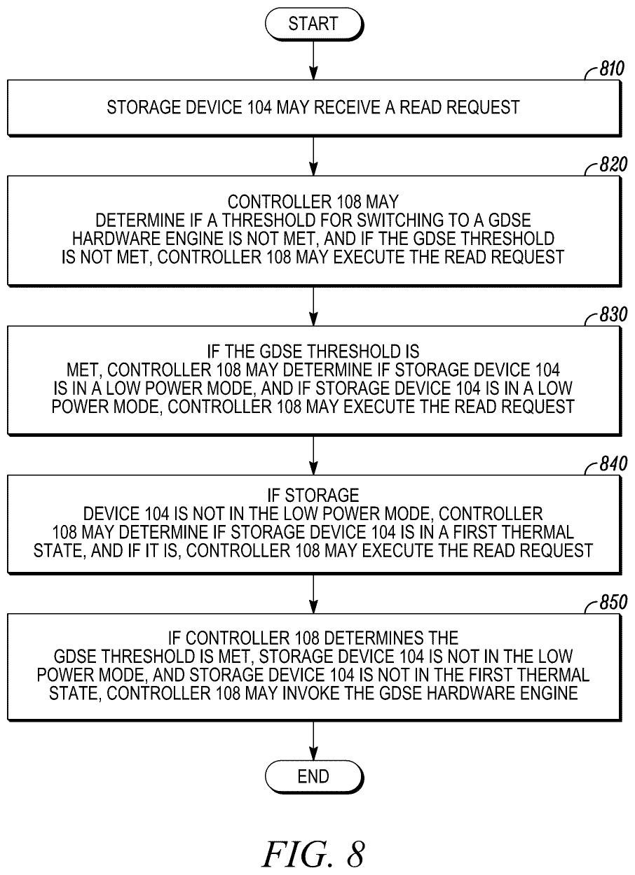

FIG. 8 is an example flow diagram for optimizing power usage on a storage device when executing a read request in accordance with some implementations. At 810, storage device 104 may receive a read request. At 820, controller 108 may determine if a threshold for switching to a GDSE hardware engine is not met, and if the GDSE threshold is not met, controller 108 may execute the read request. At 830, if the GDSE threshold is met, controller 108 may determine if storage device 104 is in a low power mode, and if storage device 104 is in a low power mode, controller 108 may execute the read request. At 840, if storage device 104 is not in the low power mode (for example, if storage device is in an active power mode), controller 108 may determine if storage device 104 is in a first thermal state, and if it is, controller 108 may execute the read request. At 850, if controller 108 determines the GDSE threshold is met, storage device 104 is not in the low power mode, and storage device 104 is not in the first thermal state, controller 108 may invoke the GDSE hardware engine. As indicated above FIG. 8 is provided as an example. Other examples may differ from what is described in FIG. 8.

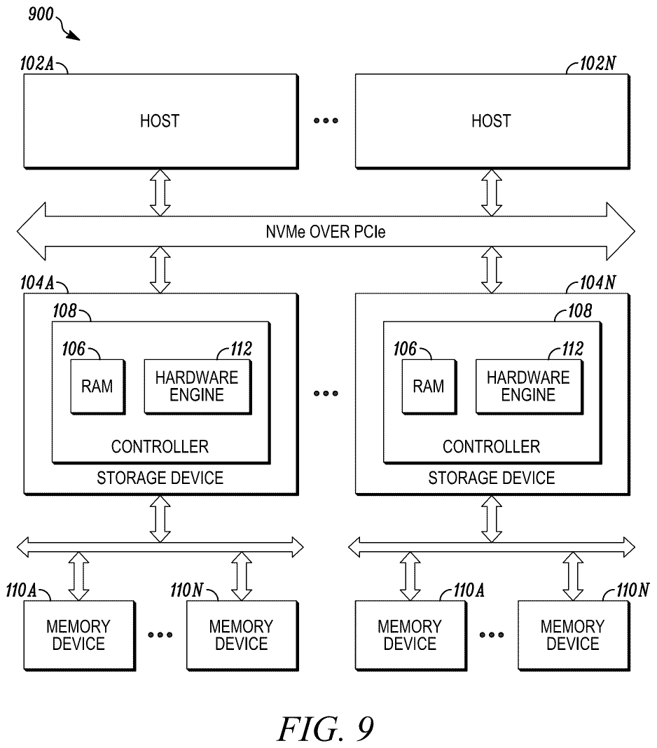

FIG. 9 is a diagram of an example environment in which systems and/or methods described herein are implemented. As shown in FIG. 9, Environment 900 may include hosts 102a-102n (referred to herein as host(s) 102), and one or more storage devices 104a-104n (referred to herein as storage device(s) 104). Storage device 104 may include a controller 108 to optimize power usage on storage device 104 by selectively invoking a hardware engine. Hosts 102 and storage devices 104 may communicate via Non-Volatile Memory Express (NVMe) over peripheral component interconnect express (PCI Express or PCIe), SD, or the like.

Devices of Environment 900 may interconnect via wired connections, wireless connections, or a combination of wired and wireless connections. For example, the network in FIG. 9 may include NVMe over Fabric(NVMe-oF) Internet Small Computer Systems Interface(iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 9 are provided as an example. In practice, there may be additional devices and/or networks, fewer devices and/or networks, different devices and/or networks, or differently arranged devices and/or networks than those shown in FIG. 9. Furthermore, two or more devices shown in FIG. 9 may be implemented within a single device, or a single device shown in FIG. 9 may be implemented as multiple, distributed devices. Additionally, or alternatively, a set of devices (e.g., one or more devices) of Environment 900 may perform one or more functions described as being performed by another set of devices of Environment 900.

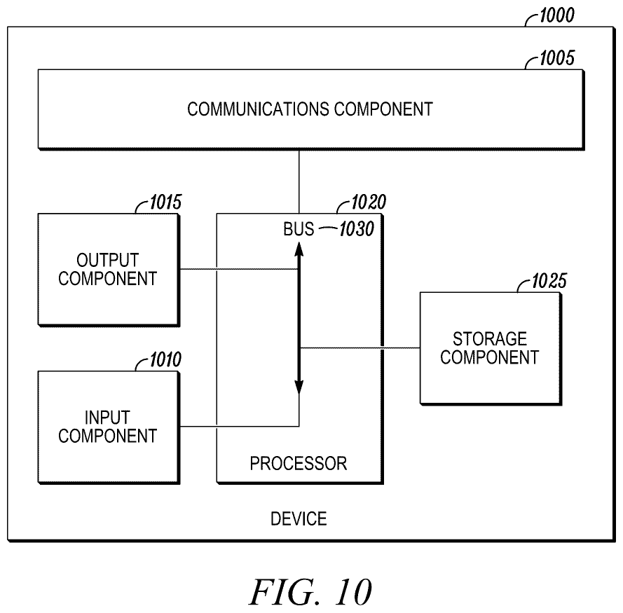

FIG. 10 is a diagram of example components of one or more devices of FIG. 1. In some implementations, host 102 may include one or more devices 1000 and/or one or more components of device 1000. Device 1000 may include, for example, a communications component 1005, an input component 1010, an output component 1015, a processor 1020, a storage component 1025, and a bus 1030. Bus 1030 may include components that enable communication among multiple components of device 1000, wherein components of device 1000 may be coupled to be in communication with other components of device 1000 via bus 1030.

Input component 1010 may include components that permit device 1000 to receive information via user input (e.g., keypad, a keyboard, a mouse, a pointing device, and a network/data connection port, or the like), and/or components that permit device 1000 to determine the location or other sensor information (e.g., an accelerometer, a gyroscope, an actuator, another type of positional or environmental sensor). Output component 1015 may include components that provide output information from device 1000 (e.g., a speaker, display screen, and network/data connection port, or the like). Input component 1010 and output component 1015 may also be coupled to be in communication with processor 1020.

Processor 1020 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1020 may include one or more processors capable of being programmed to perform a function. Processor 1020 may be implemented in hardware, firmware, and/or a combination of hardware and software.

Storage component 1025 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 1020. A memory device may include memory space within a single physical storage device or memory space spread across multiple physical storage devices. Storage component 1025 may also store information and/or software related to the operation and use of device 1000. For example, storage component 1025 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 1005 may include a transceiver-like component that enables device 1000 to communicate with other devices, such as via a wired connection, a wireless connection, or a combination of wired and wireless connections. The communications component 1005 may permit device 1000 to receive information from another device and/or provide information to another device. For example, communications component 1005 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 1005 may also include one or more broadband and/or narrowband transceivers and/or other similar types of wireless transceiver configurable to communicate via a wireless network for infrastructure communications. Communications component 1005 may also include one or more local area network or personal area network transceivers, such as a Wi-Fi transceiver or a Bluetooth transceiver.

Device 1000 may perform one or more processes described herein. For example, device 1000 may perform these processes based on processor 1020 executing software instructions stored by a non-transitory computer-readable medium, such as storage component 1025. As used herein, the term “computer-readable medium” refers to a non-transitory memory device. Software instructions may be read into storage component 1025 from another computer-readable medium or from another device via communications component 1005. When executed, software instructions stored in storage component 1025 may cause processor 1020 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 10 are provided as an example. In practice, device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to optimize power usage on the storage device through selective execution of a hardware engine, the storage device comprises:
a hardware engine configured to perform a specific task on the storage device using operational power provided by the storage device; and
a controller configured to perform the specific task using processing power of the storage device, to compare an efficiency of the hardware engine in performing the specific task in a given time unit against the operational power, to one of i) keep the hardware engine in an idle state and ii) switch off the hardware engine and execute the specific task when the controller can execute the specific task within the given time unit with a given level of efficiency, and invoke the hardware engine to execute the specific task when the controller cannot execute the specific task within the given time unit with the given level of efficiency, wherein when the controller invokes the hardware engine the storage device consumes the processing power and the operational power.

2. The storage device of claim 1, wherein when the hardware engine is in the idle state, the hardware engine consumes power in a base power mode, wherein power consumed in the base power mode is less than the operational power.

3. The storage device of claim 1, wherein the controller compares at least one threshold defined according to a quality-of-service requirement with a workload to determine the efficiency of the hardware engine in performing the specific task in the given time unit.

4. The storage device of claim 1, wherein the controller monitors an available resource to determine the efficiency of the hardware engine in performing the specific task in the given time unit.

5. The storage device of claim 1, wherein the controller monitors at least one of a power mode and a power state of the storage device to determine the efficiency of the hardware engine in performing the specific task in the given time unit.

6. The storage device of claim 1, wherein the controller
one of i) keeps the hardware engine in the idle state and ii) switches off the hardware engine and executes the specific task on the controller when the storage device is in one of a low power mode and a first thermal state, and
invokes the hardware engine to execute the specific task when the storage device is in one of an active power mode and a second thermal state.

7. The storage device of claim 1, wherein the storage device operates using multiple protocols and the controller
one of i) keeps the hardware engine in the idle state and ii) switches off the hardware engine and executes the specific task on the controller when the storage device is using a first protocol, and
invokes the hardware engine to execute the specific task when the storage device is using a second protocol.

8. The storage device of claim 1, wherein the storage device operates using concurrent protocols and the controller
one of i) keeps the hardware engine in the idle state and ii) switches off the hardware engine and executes the specific task on the controller when the storage device is processing an input/output operation with a first protocol, and
invokes the hardware engine to execute the specific task when the storage device is processing the input/output operation with a second protocol.

9. The storage device of claim 1, wherein the hardware engine is a Global Address Table (GAT) Delta Scan and Eviction (GDSE) hardware engine configured to perform a logical-to-physical flow of search, eviction, and consolidation of logical-to-physical entries.

10. The storage device of claim 9, wherein the controller evaluates an amount of random workload and a rate of accumulation of logical-to-physical delta entries within a given time window to determine if a workload threshold is reached and compare the efficiency of the hardware engine in performing the specific task in the given time unit against the operational power.

11. The storage device of claim 9, wherein the controller invokes the hardware engine when a number of logical-to-physical entries in a cache is more than the workload threshold.

12. The storage device of claim 1, wherein the operational power varies according to a workload associated with the specific task.

13. A method for optimizing power usage on a storage device through selective execution of a hardware engine, the storage device comprises a controller to execute the method comprising:
comparing an efficiency of a hardware engine configured to perform a specific task in a given time unit against operational power provided by the storage device;
one of i) keeping the hardware engine in an idle state and ii) switching off the hardware engine and executing the specific task when the controller can execute the specific task within the given time unit with a given level of efficiency; and
invoking the hardware engine to execute the specific task when the controller cannot execute the specific task within the given time unit with the given level of efficiency, wherein when the controller invokes the hardware engine the storage device consumes the processing power and the operational power.

14. The method of claim 13, further comprising comparing at least one threshold defined according to a quality-of-service requirement with a workload in determining the efficiency of the hardware engine in performing the specific task in the given time unit.

15. The method of claim 13, further comprising monitoring an available resource in determining the efficiency of the hardware engine in performing the specific task in the given time unit.

16. The method of claim 13, further comprising monitoring at least one of a power mode and a power state of the storage device in determining the efficiency of the hardware engine in performing the specific task in the given time unit.

17. The method of claim 13, further comprising:
one of i) keeping the hardware engine in the idle state and ii) switching off the hardware engine and executing the specific task on the controller when the storage device is in one of a low power mode and a first thermal state; and
invoking the hardware engine to execute the specific task when the storage device is in one of an active power mode and a second thermal state.

18. The method of claim 13, further comprising operating the storage device using multiple protocols, the method further comprising:
one of i) keeping the hardware engine in the idle state and ii) switching off the hardware engine and executing the specific task on the controller when the storage device is using a first protocol; and
invoking the hardware engine to execute the specific task when the storage device is using a second protocol.

19. The method of claim 13, further comprising operating the storage device using concurrent protocols, the method further comprising:
one of i) keeping the hardware engine in the idle state and ii) switching off the hardware engine and executing the specific task on the controller when the storage device is processing an input/output operation with a first protocol, and
invoking the hardware engine to execute the specific task when the storage device is processing the input/output operation with a second protocol.

20. A method for optimizing power usage on a storage device through selective execution of a hardware engine, the storage device comprises a controller to execute the method comprising:
receiving a read request on the storage device;
determining that a threshold for switching to a hardware engine configured to perform a specific task in a given time unit using operational power provided by the storage device is met, that the storage device is not operating in a low power mode, and that the storage device is not operating in a first thermal state, and invoking the hardware engine to execute the specific task; and
one of i) determining that the threshold for switching to the hardware engine is not met, ii) that the storage device is operating in a low power mode, and iii) that the storage device is operating in the first thermal state and executing the specific task.
